(19) United States
(12) Patent Application Publication
(10) Pub. No.: US 2020/0271289 A1
(43) Pub. Date: Aug. 27, 2020

(54) Linear Lighting System and Apparatus

(71) Applicants: Robert Lang, Commerce, CA (US); Michael Bailey, Commerce, CA (US); Sam Sinai, Commerce, CA (US); Benjamin Pouladian, Commerce, CA (US)

(72) Inventors: Robert Lang, Commerce, CA (US); Michael Bailey, Commerce, CA (US); Sam Sinai, Commerce, CA (US); Benjamin Pouladian, Commerce, CA (US)

(21) Appl. No.: 16/284,557

(22) Filed: Feb. 25, 2019

(51) Int. Cl. F21S 4/28; F21S 8/06; F21V 15/015; F21V 15/00

(52) U.S. Cl. CPC F21S 4/28; F21V 15/005; F21V 15/015; F21S 8/06

(57) ABSTRACT

A linear lighting system and apparatus configured for easy and efficient installation and to reduce unattractive shadows, gaps, or light leaks is provided. In certain embodiments, the linear lighting system comprises a plurality of lighting assemblies joined contiguously together with a draw latch assembly and each of the lighting assemblies comprising a housing, a light source, and a power source. More specifically, the draw latch assembly comprises a draw latch and a latch keeper which, when engaged, removably secures a first lighting assembly to a second lighting assembly. In use, there may be more than two lighting assemblies which may be removably secured to one another in this manner in a variety of configurations.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to lighting systems and, more particularly, to a linear lighting system and apparatus wherein one or more lighting assemblies are contiguously joined together using a draw latch assembly so as to reduce installation cost and time.

### BACKGROUND

Modular linear lighting structures are typically assembled by connecting and mounting individual modules in a desired placement. Such configurations typically require the use of a number of tools, such as screwdrivers, hammers, and the like, because joining individual lighting modules requires a number of components. Indeed, screws, bolts, nuts, and various panels or other pieces often must be fastened together in an intricate and specific fashion so as to secure these lighting modules to one another. As a result, installation can be complex and time-consuming. Moreover, for those individuals not apt at handy work, installation can also prove to be expensive.

Some attempts have been made to connect individual lighting modules. U.S. Pat. No. 8,042,977 to Nourishad et al., for example, discloses a joiner device involving the fastening of a joiner tab from one lighting troffer into a corresponding joiner aperture of another lighting troffer so as to create a substantially continuous appearance. While this disclosure may provide for an aesthetically pleasing luminaire arrangement, the troffers are not tightly joined to one another. As a result, the troffers may somewhat easily separate from one another, thereby allowing light to pass between the space.

Another attempt is seen with respect to U.S. Patent Publication No. 2009/0002978 to Tran et al. This publication teaches a joiner bracket and separate bracket assembly for a linear lighting system. The major drawback of this system is that it comprises multiple parts, including small, easy-to-misplace screws, which provides a complicated arrangement.

Additionally, other companies manufacture other types of connectors to address these concerns. However, these connectors commonly involve specially adapted pieces which specifically mate up to one another. Such an arrangement is not versatile as these pieces can only join to one another.

As a result, there is a need for a visually appealing linear lighting system that can be easily and cost-efficiently installed. There further exists a need for linear lighting systems which do not require excess hardware, such as screws, bolts, and the like, and thereby do not require utilization of additional tools, to effectuate installation.

### SUMMARY

The present disclosure is directed to linear lighting systems comprising one or more lighting assemblies contiguously joined together using a draw latch assembly, thereby reducing installation cost and time, as well as, unattractive shadows, gaps, or light leaks.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the linear lighting system may comprise a plurality of lighting assemblies, one or more draw latch assemblies, and a power source. In certain exemplary embodiments, the linear lighting system may comprise a first lighting assembly and a second lighting assembly. The first lighting assembly may comprise a first housing, a draw latch, and a first light source. Similarly, the second lighting assembly may comprise a second housing, a latch keeper, and a second light source. The first housing may be slideably joinable to the second housing. Moreover, the draw latch, or latch, may engage the latch keeper to removably secure the first lighting assembly to the second lighting assembly.

The first housing may be defined peripherally by a first side, a second side, a third side, and a fourth side. In certain embodiments, each of the first, second, third, and fourth sides may be flat. In other embodiments, each of the first, second, third, and fourth sides may be curved in shape. In further embodiments, one or more of the first second, third, and fourth sides may be curved while one or more of the first second, third, and fourth sides may be flat. In some of those embodiments, the first side and the second side may be flat while the third side and the fourth side may be curved in shape.

In some embodiments, the first side and the second side may be equivalent in length and the third side and the fourth side may be equivalent in length. In such embodiments, the first side and the second side may be shorter in length relative to the third side and the fourth side. The first, second, third, and fourth sides may define an interior cavity of the first housing.

In certain embodiments, the first housing may be formed out of a metal material, such as die-cast aluminum. In other embodiments, the first housing may be formed out of plastic or other structural materials. The first housing may be configured to house the first light source and the draw latch. In some embodiments, the first housing may further house a lens, which may be operable to shield direct contact with the first light source.

The first light source may be operable to deliver light into the interior cavity of the first housing. In some embodiments, the first light source may comprise one or more light emitting diodes (LEDs) disposed along an LED strip. In such embodiments, one or more LED clips may be disposed along an interior surface of the first housing and may be operable to secure the LED strip. In other embodiments, the first light source may be various other types of light sources available in the marketplace. For instance, the first light source may be one or more fluorescent bulbs, halogen bulbs, or laser diodes. In those embodiments, there may be other clips or securing devices to hold the first light source within the first housing. Further, the first light source may be coupled to the power source so to pass electricity to the first light source. The power source may be a driver disposed within the interior cavity of the first housing or remote therefrom.

Similar to the first housing, the second housing may be defined peripherally by a first side, a second side, a third side, and a fourth side. In certain embodiments, each of the first, second, third, and fourth sides may be flat. In other embodiments, each of the first, second, third, and fourth sides may be curved in shape. In further embodiments, one or more of the first second, third, and fourth sides may be curved while one or more of the first second, third, and fourth sides may be flat. In some of those embodiments, the first side and the second side may be flat while the third side and the fourth side may be curved in shape. The first, second, third, and fourth sides may further define an interior cavity of the second housing.

In some embodiments, the first side and the second side may be equivalent in length and the third side and the fourth side may be equivalent in length. In those embodiments, the first side and the second side may be shorter in length relative to the third side and the fourth side. Moreover, in certain embodiments the first housing and the second housing may be of equivalent dimensions. In other embodiments, the first housing and the second housing may be of different dimensions.

In certain embodiments, the second housing may be formed out of a metal material, such as die-cast aluminum. In other embodiments, the second housing may be formed out of plastic or other structural materials. The second housing may be configured to house the second light source, the latch keeper, and in certain embodiments, a lens.

As with the first light source, the second light source may be operable to deliver light into the interior cavity of the second housing. Additionally, in certain embodiments, the second light source may comprise one or more light emitting diodes (LEDs) disposed along an LED strip. In such embodiments, the second housing may have one or more LED clips disposed along an interior surface thereof. Such LED clips may be operable to secure the LED strip.

One of ordinary skill in the art will understand that other light sources may be adapted to provide illumination according to this disclosure. Indeed, in some embodiments, the first light source and the second light source may be the same type of light source. In other embodiments, the first light source and the second light source may be different types of light sources.

The second light source may be coupled to the same power source as the first light source so as to pass electricity to the second light source so as to coordinate illumination with the first light source. In other embodiments, the second light source may be coupled to a different power source than the first light source and as a result, the second light source may be controllable separately from the first light source. In some embodiments, the power source may be disposed within the interior cavity of the second housing or remote therefrom.

The draw latch may be disposed along the interior surface of the first housing while the latch keeper may be disposed along the interior surface of the second housing. Further, the draw latch may be oriented so that the draw latch may engage the latch keeper. Similarly, the latch keeper may be oriented so that the draw latch may engage it.

The draw latch may comprise a handle, a claw member, and a pivot axis. The latch keeper may comprise a catching member. The handle may pivot around the pivot axis which may cause the claw member to engage the catching member. When the claw member engages the catching member, the first housing and the second housing may be drawn together and removably secured to one another. Such an arrangement may minimize gaps and therefore, light leaks between the first housing and the second housing.

Both the first housing and the second housing may be configured such that the first housing is slideably joinable to the second housing. When slideably joined, the first side of the first housing may abut the second side of the second housing. Other sides of the second, third, and fourth sides of the first housing may abut other sides of the first, third, and fourth sides of the second housing.

Moreover, the first housing may slideably join the second housing in a variety of arrangements. Indeed, the first housing and the second housing may slideably join such that the first and second housings are placed linearly in parallel or perpendicularly. For example, the first housing may slideably join the second housing so as to form a T configuration. As another example, the first housing may slideably join the second housing so as to form an L configuration.

In many embodiments, more than two lighting assemblies, that is, a plurality of lighting assemblies may be provided. In such embodiments, the plurality of lighting assemblies may be contiguously joined with one or more draw latch assemblies, as discussed previously.

Additionally, the linear lighting system may be mounted to a variety of surfaces. By way of example, each of the lighting assemblies may be mounted to a wall, ceiling, or countertop. Each of the lighting assemblies may further be suspended by cables or stems. Alternatively, each of the lighting assemblies may be mounted directly to a desired surface.

Accordingly, it is an object of the present invention to provide a linear lighting system which does not require excess hardware and is simple and efficient to install. Another object of this invention is to provide an aesthetically pleasing lighting system which involves the seamless joining of a plurality of lighting assemblies so as to avoid unattractive shadows, gaps, or light leaks.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a perspective view of an embodiment of the linear lighting system and apparatus.

FIG. 2 shows a top down view of an embodiment of the linear lighting system and apparatus.

FIG. 3 shows an exploded view of the linear lighting system and apparatus.

FIG. 4 shows a top down view of an embodiment of the linear lighting system and apparatus.

FIG. 5 shows a perspective view of the draw latch assembly of the linear lighting system and apparatus.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

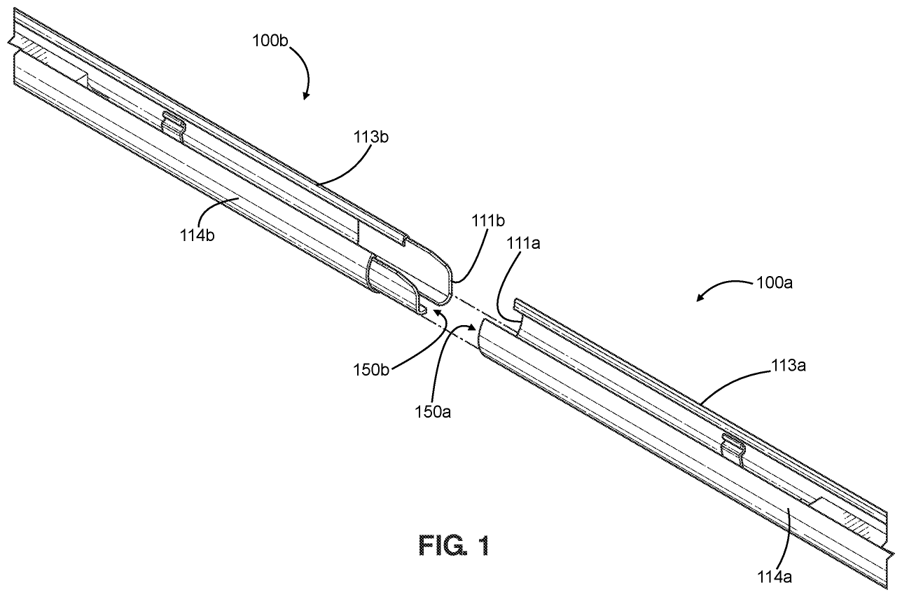

With reference to FIG. 1, one embodiment of the linear lighting system may comprise a plurality of lighting assemblies, that is, a first lighting assembly 100a and a second lighting assembly 100b. For purposes of brevity, linear lighting systems featuring two lighting assemblies arranged linearly in parallel are shown and described, however, it will be understood that various styles and configurations of linear lighting systems may be adapted according to this disclosure to provide efficient installation without sacrificing even illumination.

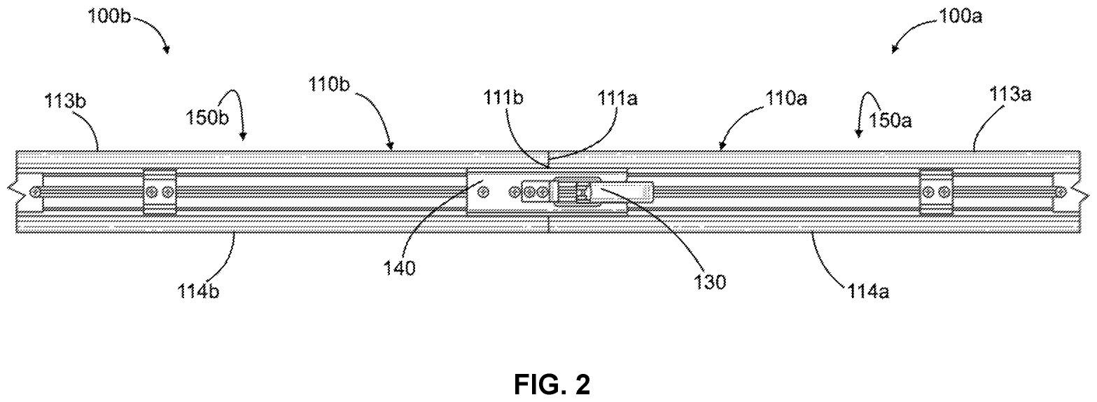

An alternative view of the exemplary linear lighting system is shown in FIG. 2. In some embodiments, the first lighting assembly 100a may comprise a first housing 110a, a first light source 120a (removed for visibility), and a draw latch 130. Also, the second lighting assembly 100b may comprise a second housing 110b, a second light source 120b (removed for visibility), and a latch keeper 140. The first housing may be peripherally defined by a plurality of sides. In some embodiments, the first housing may be defined by a first side 111a, a second side 112a, a third side 113a, and a fourth side 114a (the second side 112a having been obscured by the cross-section). The first side 111a, the second side 112a, the third side 113a, and the fourth side 114a may define an interior cavity 150a of the first housing 110a.

In certain embodiments, including that shown with reference back to FIG. 1, the first side 111a and the second side 112a (the second side 112a having been obscured by the cross-section) may be flat while the third side 113a and the fourth side 114a may be curved, or arcuate, in shape. In other embodiments, each of the first, second, third, and fourth sides 111a, 112a, 113a, 114a may be flat. In further embodiments, each of the first, second, third, and fourth sides 111a, 112a, 113a, 114a may be arcuate. One of ordinary skill in the art will recognize that one or more of each of the first, second, third, and fourth sides 111a, 112a, 113a, 114a may be variously arcuate or flat.

Additionally, in some embodiments, including those depicted in the FIGS., the first side 111a and the second side 112a may be equivalent in length while the third side 113a and the fourth side 114a may be equivalent in length. Moreover, in those embodiments, the first side 111a and the second side 112a may be shorter in length relative to the third side 113a and the fourth side 114a. In other embodiments, the third side 113a and the fourth side 114a may be shorter in length relative to the first side 111a and the second side 112a.

In certain embodiments, the first housing 110a may be formed out of a metal material. By way of example, the first housing 110a may be formed out of aluminum. In other embodiments, the first housing 110a may be formed out of zinc, brass, copper, lead, pewter, tin, steel, and alloys thereof. In such embodiments, the first housing 110a may act as a heat sink in that it may be operative to dissipate heat generated by any energy source, such as an electrical driver or lights, housed therein. In other embodiments, the first housing 110a may be formed out of a plastic material. Of course, one of ordinary skill in the art will understand the first housing 110a may be formed out of other structural materials. Indeed, the first housing 110a may be formed out of a rugged material capable of housing the first light source 120a and the draw latch 130.

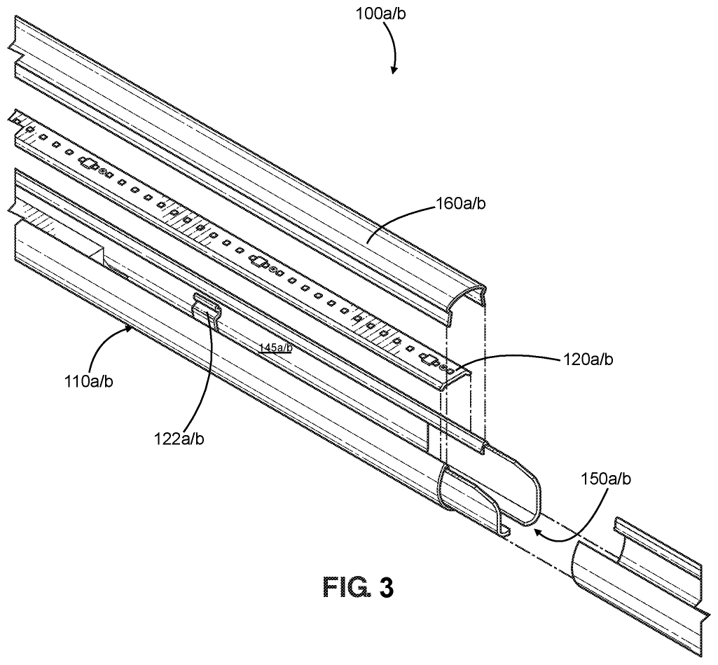

With attention now to FIG. 3, the first light source 120a may be operable to deliver light into the interior cavity 150a of the first housing 110a. In certain exemplary embodiments, such as that seen in FIG. 3, the first light source 120a may comprise one or more light emitting diodes (LEDs) in electrical communication with one another disposed along an LED strip. In other embodiments, it is understood that other light sources, such as laser diodes, fluorescent, incandescent, halogen, or any other light source and/or combination of the same known for use in luminaires may be substituted as the first light source 120a in embodiments of the invention.

In some embodiments, the LED strip 120a may be secured to an interior surface 145a of the first housing 110a by one or more LED clips 122a. In such embodiments, the LED strip 120a may be removably secured to the one or more LED clips 122a. In embodiments wherein the first light source 120a comprises a different type of light source, such as one or more fluorescent or halogen bulbs, other types of clips or other securing devices may be disposed along the interior surface 145a of the first housing 110a so as to secure the first light source 120a thereto.

A means for electrically coupling the first light source 120a to an external power supply may be disposed within the interior cavity 150a. By way of example, in some embodiments, such means may be a driver disposed along the interior surface 145a. In other embodiments, the driver may be placed outside the first housing 110a. As another example, the means for electrically coupling the first light source 120a may be a ballast. A person of ordinary skill in the art will recognize other means for electrically coupling the first light source 120a to an external power source based on the type of light source utilized.

The first housing 110a may further house a lens 160a. The lens 160a may be operable to shield direct contact with the first light source 120a and reduce glare. The lens 160a may be formed out of any optical grade translucent material. In some embodiments, the lens 160a may be formed out of a transmissive plastic, such as acrylic or polycarbonate. In other embodiments, the lens 160a may be formed out of glass. In further embodiments, the lens 160a may comprise a micro-prismatic lens material which may modify the trajectory of light as it passes through the micro-prisms thereof so as to uniformly disperse light on an environment.

Turning attention back to FIG. 1, as with the first housing 110a, the second housing 110b may be defined peripherally by a first side 111b, a second side 112b (the second side 112b having been obscured by the cross-section), a third side 113b, and a fourth side 114b, which may further define an interior cavity 150b. Similar to the first, second, third, and fourth sides 111a, 112a, 113a, 114a of the first housing 110a, the first, second, third, and fourth sides 111b, 112b, 113b, 114b of the second housing 110b may be variously flat or curved in shape.

In some embodiments, the first side 111b and the second side 112b may be equivalent in length while the third side 113b and the fourth side 114b may be equivalent in length. Further, in such embodiments, the first side 111b and the second side 112b may be shorter in length or longer in length relative to the third side 113b and the fourth side 114b. Additionally, in certain exemplary embodiments, the first housing 110a and the second housing 110b may be of equivalent dimensions while, in other embodiments, the first housing 110a and the second housing 110b may be variously and differently shaped.

In certain embodiments, the second housing 110b may be formed out of a metal material, such as aluminum. In other embodiments, the second housing 110b may be formed out of other metal materials, such as zinc, brass, copper, lead, pewter, tin, steel, and alloys thereof. In other embodiments, the second housing 110b may be formed out of a plastic material or other structural materials. The second housing 110b may be further configured to house the second light source 120b and the latch keeper 140.

FIG. 3 provides an exploded view of any of the plurality of lighting assemblies and may be illustrative of either the first lighting assembly 100a or the second lighting assembly 100b. With attention to FIG. 3, in some embodiments, the second lighting assembly 100b may comprise the second light source 120b, which may be operable to deliver light into the interior cavity 150b of the second housing 110b. In the embodiment shown, the second light source 120b may comprise one or more light emitting diodes (LEDs) in electrical communication with one another disposed along an LED strip. In alternate embodiments, the second light source 120b may be one or more laser diodes, fluorescent bulbs, incandescent bulbs, halogen bulbs, or any other light source and/or combination of the same.

In some embodiments, the first light source 120a and the second light source 120b may be of the same type of light source. Meanwhile, in other embodiments, the first light source 120a and the second light source 120b may be different types. To that end, the first light source 120a and the second light source 120b may be coupled to the same power source such that the illumination of the first light source 120a may be coordinated to that of the second light source 120b. However, in other embodiments, there may be more than one power source and as such, the first light source 120a and the second light source 120b may have different means for electrically coupling to an external power supply. In some of these embodiments, the second light source 120b may be separately controllable from the first light source 120a.

In some embodiments wherein the LED strip may provide the second light source 120b, similar to the first lighting assembly, the LED strip 120b may be removably secured to an interior surface 145b of the second housing 110b by one or more LED clips 122b. In embodiments wherein the second light source 120b may comprise a different type of light source, such as one or more fluorescent or halogen bulbs, other types of clips or other securing devices may be disposed along the interior surface 145b of the second housing 110b.

As with the first housing 110a, the second housing 110b may further house a lens 160b, which may be operable to shield direct contact with and reduce glare from the second light source 120b. The lens 160b may be similarly formed out of any optical grade translucent material, such as a transmissive plastic or glass. Further, the lens 160b may comprise a micro-prismatic lens material which may modify the trajectory of light as it passes through the micro-prisms thereof.

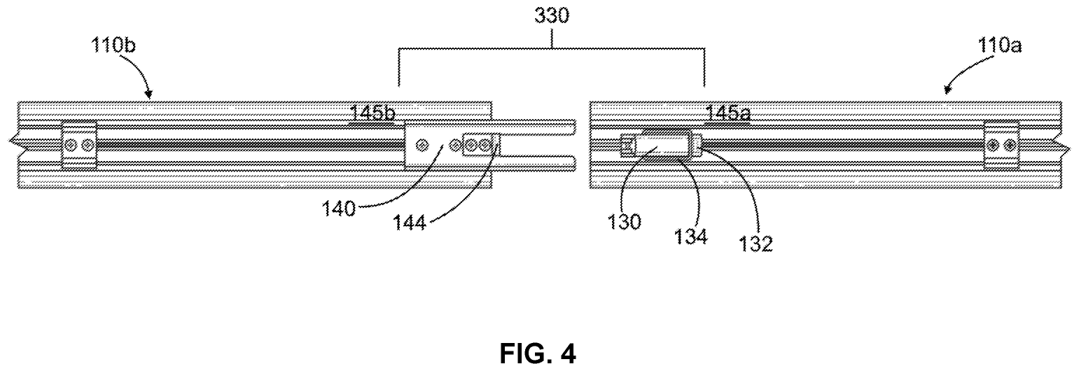

With reference now to FIG. 4, a draw latch assembly 330 may comprise the draw latch 130 and the latch keeper 140. In some embodiments, the draw latch 130 may be disposed along the interior surface 145a of the first housing 110a and the latch keeper 140 may be disposed along the interior surface 145b of the second housing 110b.

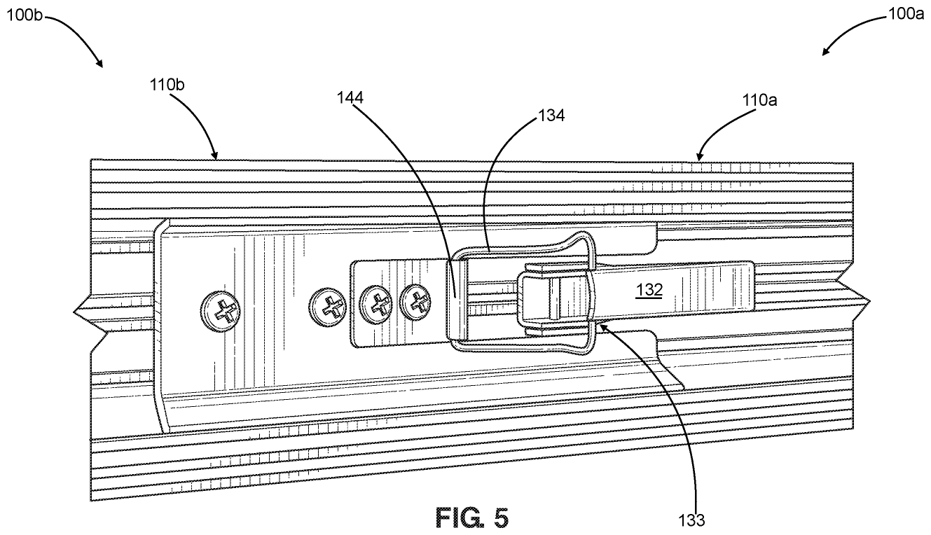

FIG. 4 illustrates the draw latch 130 and the latch keeper 140 in an open, unengaged position. FIG. 5, on the other hand, illustrates the draw latch 130 and the latch keeper 140 in a closed, engaged position. As can be seen in FIGS. 4-5, the draw latch may comprise a handle 132, a pivot axis 133, and a claw member 134. The handle 132 may be operable to pivot around the pivot axis 133 and which may, in turn, cause the claw member 134 to actuate. The pivot axis 133 may further comprise one or more springs, levers, or other mechanisms to effectuate movement of the handle 132 and the claw member 134. The latch keeper 140 may further comprise a catching member 144.

FIG. 5 illustrates the draw latch 130 engaged with the latch keeper 140. In particular, when the handle 132 may be pivoted around the pivot axis 133, the claw member 134 may engage with the catching member 144. When the claw member 134 may engage the catching member 144, the first housing 110a and the second housing 110b may be drawn together. Indeed, the first housing 110a and the second housing 110b may be configured so as to be slideably joinable to one another. Further, when the claw member 134 may engage the catching member 144, the first lighting assembly 100a may be removably secured to the second lighting assembly 100b so as to form a seamless connection. Moreover, when the first lighting assembly 100a may be removably secured to the second lighting assembly 100b, any gaps and, therefore, light leaks from the respective interior cavities 150a, 150b may be minimized or eliminated.

A person of ordinary skill in the art will recognize that the linear lighting system may be mounted to a variety of surfaces. In some embodiments, the first lighting assembly 100a and the second lighting assembly 100b may be mounted directly and flushly to a ceiling. In other embodiments, the first lighting assembly 100a and the second lighting assembly 100b may be suspended from the ceiling utilizing one or more cables, stems, or cords. In still other embodiments, the first lighting assembly 100a and the second lighting assembly 100b may be mounted to a wall, countertop, or other surface.

While each embodiment of the linear lighting system has depicted the first lighting assembly 100a and the second lighting assembly 100b slideably joined in linear and parallel fashion, according to other embodiments not shown in the FIGS., the first lighting assembly 100a and the second lighting assembly 100b may be slideably joined and arranged in a variety of configurations. The first lighting assembly 100a and the second lighting assembly 100b may be joined in a parallel or perpendicular fashion. Furthermore, the first lighting assembly 100a may be joined to the second lighting assembly 100b in a T or an L configuration. One of ordinary skill in the art will understand that numerous other configurations are possible. Moreover, in some embodiments, other quantities of lighting assemblies may be provided and therefore, may be joined together in a variety of configurations.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the plurality of lighting assemblies may be slideably joined together in a multitude of different configurations. As another example, additional elements may be present, such as a heat sink or light guide. Accordingly, it is intended that the invention not be limited, except as by the appended claims.

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the linear lighting system and apparatus with which that terminology is associated. In general, the terms used in the following claims should not be constructed to limit the linear lighting system and apparatus to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the linear lighting system and apparatus is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the linear lighting system and apparatus.

What is claimed is:

1. A linear lighting system comprising:
a first lighting assembly, wherein the first light assembly comprises
a first housing;
a draw latch;
a first light source;
a second lighting assembly, wherein the second light assembly comprises
a second housing;
a latch keeper;
a second light source;
a power source;
wherein the first housing is slideably joinable to the second housing; and
wherein the draw latch engages the latch keeper to removably secure the first lighting assembly to the second lighting assembly.

2. The linear lighting system of claim 1, wherein the first light source is a first LED strip and the second light source is a second LED strip.

3. The linear lighting system of claim 2, wherein the first housing further comprises one or more LED clips configured to removably secure the first LED strip and the second housing further comprises one or more LED clips configured to removably secure the second LED strip.

4. The linear lighting system of claim 1, wherein the first housing is slideably joinable to the second housing in a straight configuration.

5. The linear lighting system of claim 1, wherein the first housing is slideably joinable to the second housing in an L configuration.

6. The linear lighting system of claim 1, wherein the first housing is slideably joinable to the second housing in a T configuration.

7. The linear lighting system of claim 1, further comprising at least one lens.

8. The linear lighting system of claim 7, wherein the first lighting assembly has a first lens and the second lighting assembly has a second lens.

9. A linear lighting fixture comprising:
a first housing having a first light source;
a second housing having a second light source;
a draw latch assembly comprising a latch and a latch keeper, wherein said draw latch assembly is configured to removably secure the first housing to the second housing; and
means for electrically coupling the first and second light sources to an external power supply.

10. The linear lighting fixture of claim 9, wherein the latch comprises a handle, a pivot axis, and a claw member, and wherein the latch keeper comprises a catching member.

11. The linear lighting fixture of claim 10, wherein when the handle is pivoted around the pivot axis, the claw member engages the catching member to removably secure the latch to the latch keeper.

12. A linear lighting system comprising:
a plurality of lighting assemblies;
one or more draw latch assemblies; and
wherein the one or more draw latch assemblies are operable to contiguously join the plurality of lighting fixtures.

13. The linear lighting system of claim 12, wherein each of the plurality of lighting fixtures comprises at least one light source and a power source.

14. The linear lighting system of claim 13, wherein each of the plurality of lighting fixtures further comprises a lens.
